(19) United States
(12) Patent Application Publication
(10) Pub. No.: US 2018/0315009 A1
(43) Pub. Date: Nov. 1, 2018

(54) Inventory Analysis Device and Inventory Analysis Method

(71) Applicant: Hitachi, Ltd., Chiyoda-ku, Tokyo (JP)

(72) Inventors: Akihisa TSUJIBE, Tokyo (JP); Kentaro TAGUCHI, Tokyo (JP)

(21) Appl. No.: 15/770,887

(22) PCT Filed: Nov. 10, 2015
(86) PCT No.: PCT/JP2015/081559

§ 371 Date: Apr. 25, 2018

(51) Int. Cl. G06Q 10/08; G06Q 10/06

(52) U.S. Cl. CPC G06Q 10/087; G06Q 10/06315; G06Q 10/06395

(57) ABSTRACT

The invention is directed to an inventory analysis device that analyzes whether one of a warehousing side and a releasing side causes an inventory of a target article to what extent. The inventory analysis device includes a warehousing-induced quantity calculating portion that calculates, from information on warehousing of the target article, an inventory fluctuation quantity caused by the warehousing; and a releasing-induced quantity calculating portion that calculates, from information on releasing of the target article, an inventory fluctuation quantity caused by the releasing.

### TECHNICAL FIELD

The present invention relates to an inventory analysis device and an inventory analysis method.

### BACKGROUND ART

Companies, which produce products with prospects or procure parts, make a plan with accuracy as high as possible to reduce a difference from an actual result and suppress occurrence of excess or deficiency of inventory. In practice, however, a difference will always arise between a plan and actual results. At this time, the reason why the difference arises can be analyzed by comparison between plan data and result data (PTLs 1 and 2).

In a technique disclosed in PTL 1, comparison is made between a production plan and an actual result in a production process, a result value of each fluctuation element (a procurement lead time of the part, a manufacturing lead time, a yield for each manufacturing step, or an inventory quantity) is compared with a reference value, and an alert is output when a difference between both values is out of the range of a threshold.

In a technique disclosed in PTL 2, a comparison is made between a transportation plan and an actual result in a part procurement, an original transportation plan created based on an unfixed order, a transportation plan created based on a fixed order, and a transportation result are compared with each other. Then, in the technique disclosed in PTL 2, determination is performed depending on whether a difference has arisen as a result of modifying the original transportation plan or whether a difference has arisen between the plan and the actual result because the transportation could not be carried out according to the transportation plan.

### CITATION LIST

### Patent Literature

PTL 1: JP-A-2014-197308

PTL 2: JP-A-2005-289543

### SUMMARY OF INVENTION

### Technical Problem

In the techniques disclosed in PTLs 1 and 2, an alarm can be issued by detection of the difference between the plan and the actual result, but the cause of inventory excess or deficiency can hardly be investigated. In the related art, it can hardly analyze whether the inventory excess or deficiency is caused by problems on a warehousing side or is caused by problems on a releasing side. For this reason, for example, it can hardly specify whether the inventory occurs due to problems of a material purchasing department or occurs due to problems of a production department, and appropriate inventory management can hardly be performed.

The present invention has been made in view of the above problems, and provides an inventory analysis device and an inventory analysis method which can analyze whether which one of the warehousing side and the releasing side causes the inventory of the target article to what extent.

### Solution to Problem

In order to solve the above problem, an inventory analysis device according to the present invention is to analyze an inventory of a target article, and includes: a warehousing-induced quantity calculating portion that calculates, from information on warehousing of the target article, an inventory fluctuation quantity caused by the warehousing; and a releasing-induced quantity calculating portion that calculates, from information on releasing of the target article, an inventory fluctuation quantity caused by the releasing.

### Advantageous Effects of Invention

According to the present invention, it is possible to calculate the inventory fluctuation quantity caused by the warehousing of the target article and the inventory fluctuation quantity caused by the releasing and to analyze the cause of the inventory of the target article.

### BRIEF DESCRIPTION OF DRAWINGS

FIG. 1 is a functional block diagram of an inventory analysis device.

FIG. 2 is a flowchart of an inventory tracing process performed by the inventory analysis device.

FIG. 3 illustrates a configuration example of inventory transition information.

FIG. 4 illustrates a configuration example of consumption result information.

FIG. 5 illustrates a configuration example of order result information.

FIG. 6 illustrates a configuration example of warehousing result information.

FIG. 7 illustrates a configuration example of consumption plan information.

FIG. 8 illustrates a configuration example of master information.

FIG. 9 illustrates a configuration example of analysis target information.

FIG. 10 illustrates a configuration example of inventory excess/deficiency reason information.

FIG. 11 illustrates an example of an inventory excess/deficiency reason information screen.

FIG. 12 is an explanatory diagram illustrating an example of a process of setting of an analysis target and an analysis target setting screen according to a second embodiment.

FIG. 13 is a flowchart of an inventory tracing process according to a third embodiment.

### DESCRIPTION OF EMBODIMENTS

Embodiments of the invention will be described below with reference to the drawings. In the embodiments, analysis is performed on whether the cause (reason) of inventory excess or deficiency of the target article results from which one of warehousing and releasing to what extent. Examples of the target article may include electric appliances, mechanical products, cars, trains, aircrafts, transportation apparatuses such as a conveyor and an escalator, generators, controllers, control panels, storage devices, network storages such as NAS (Network Attached Storage), servers, and water treatment devices.

Upon production of these target articles, since product production and part procurement are performed at an expectation value, the inventory excess or deficiency occurs due to a demand fluctuation. In addition, in the case of the part procurement, the quantity is ordered in bulk (a bundled order) or the delivery date is delayed, and thus deviation occurs between the required quantity and the actual quantity. Therefore, it is a task to classify and investigate reasons for the inventory excess or deficiency for each factor and to take measures against each factor.

Therefore, in the embodiments, as described below, the excess/deficiency reasons are classified into two types, that is, the cause of warehousing and the cause of releasing to clarify factors at the time of inventory excess or deficiency of the target article, and the degree of influence is calculated for each cause. In the embodiments, the inventory excess/deficiency reason is calculated in order of warehousing and releasing of the target article from comparison of a theoretical value and an actual value and is then displayed.

The inventory tracing device as an “inventory analysis device” uses result information of the target article, plan information, and master information as input information and classifies the degree of difference between a plan and an actual result for each of the target article (for each item) into the cause of warehousing and the cause of releasing. Thus, the inventory tracing device can clarify the history of inventory at the point of time of determination and present the result to an operator (user). Hereinafter, the “target article” may be referred to as “item”.

### First Embodiment

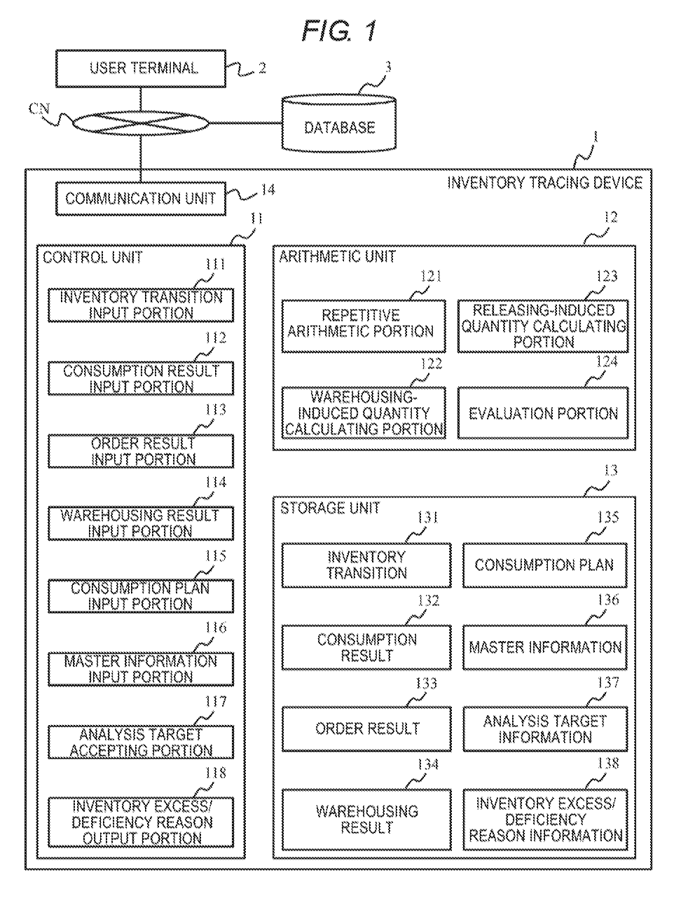

FIG. 1 is a functional block diagram of an inventory tracing device 1 according to the embodiment. The inventory tracing device 1 is configured as a computer. Focusing on the function, the inventory tracing device 1 includes, for example, a control unit 11, an arithmetic unit 12, a storage unit 13, and a communication unit 14. Information necessary for the processing of the arithmetic unit 12 can be acquired from a user terminal 2 and a database 3 via the communication unit 14 and a network CN.

The control unit 11, the arithmetic unit 12, and functional portions included in these units may be configured using hardware such as a circuit device that implements these functions, or may be configured such that software for implementing these functions may be executed by an arithmetic device.

The control unit 11 includes, for example, an inventory transition input portion 111, a consumption result input portion 112, an order result input portion 113, a warehousing result input portion 114, a consumption plan input portion 115, a master information input portion 116, an analysis target accepting portion 117 used as a “period setting portion”, and an inventory excess/deficiency reason output portion 118 used as an “output portion”.

The arithmetic unit 12 includes, for example, a repetitive arithmetic portion 121, a warehousing-induced quantity calculating portion 122, a releasing-induced quantity calculating portion 123, and an evaluation portion 124.

The storage unit 13 stores, for example, an inventory transition information 131, a consumption result information 132, an order result information 133, a warehousing result information 134, a consumption plan information 135, a master information 136, an analysis target information 137, and an inventory excess/deficiency reason information 138. For example, the storage unit 13 is a storage device such as a hard disk drive or a flash memory device. Operations of the respective functional portions and details of the respective types of information described above will be described below.

The communication unit 14 is an interface device for communicating with the user terminal 2 or the database 3 which are external devices, via the communication network CN. The communication unit 14 may use either of wired communication or wireless communication.

The network CN is usually a communication network managed by a user organization such as a LAN (Local Area Network). However, being not limited thereto, the network CN may be a communication network using a part of a general public line such as Internet or a general public line such as WAN (Wide Area Network) or VPN (Virtual Private Network).

The database 3 is, for example, a system such as ERP (Enterprise Resource Planning), a database in which data conforming thereto is stored, or a simple storage device.

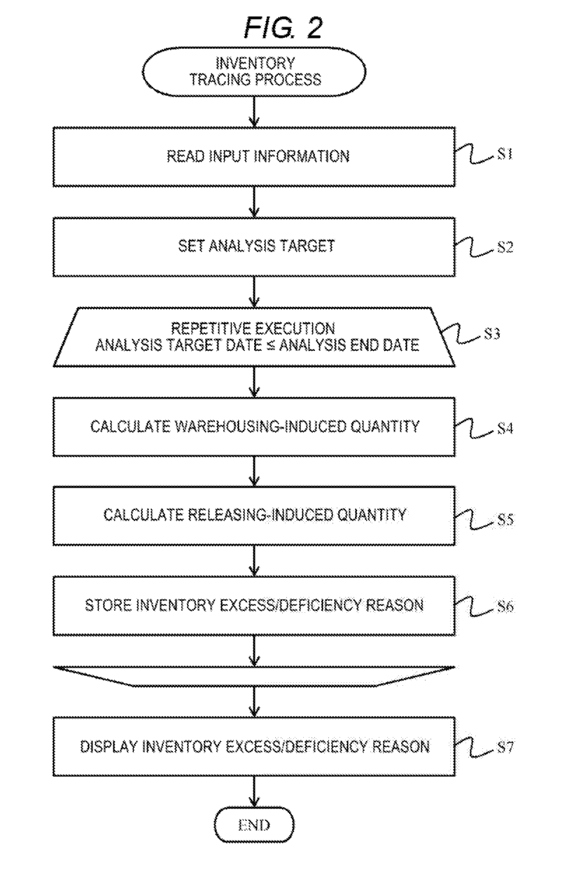

FIG. 2 is a flowchart for explaining an operation of the inventory tracing device 1. Hereinafter, respective steps illustrated in FIG. 2 will be described in detail.

### (FIG. 2: Step S1: Reading of Input Information)

Step S1 is a process of reading input information which is performed by the respective input portions 112 to 116 of the control unit 11. Information necessary for the respective input portions is input to the inventory tracing device 1 from the user terminal 2 or the database 3 via the communication unit 14. Alternatively, the information necessary for the respective input portions can be directly input to the inventory tracing device 1 via an input interface (not illustrated). The information input in this manner is stored in the storage unit 13 via the respective input portions 112 to 116 of the control unit 11.

### <Inventory Transition Input Portion>

Upon accepting the inventory transition information 131, the inventory transition input portion 111 stores the information in the storage unit 13. The inventory transition information 131 is information on a daily inventory quantity of each item as “target article”.

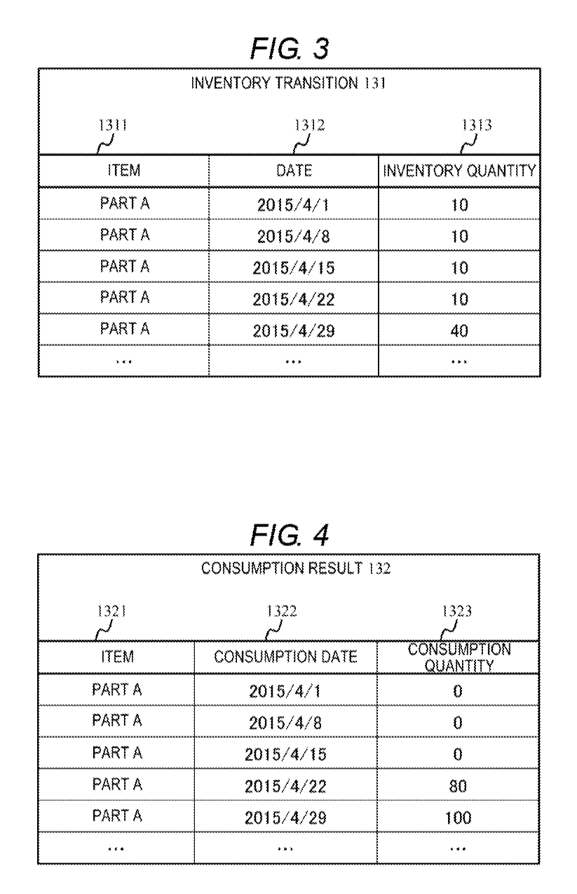

FIG. 3 illustrates an example of a data table of the inventory transition information 131. The data table of the inventory transition information 131 illustrated in FIG. 3 stores, for example, an item 1311, a date 1312, and an inventory quantity 1313. Here, since the visual numeric character of the inventory transition information 131 varies depending on data acquisition timing, it is important that it is data of the same time every day or the timing when the same processing is finished.

### <Consumption Result Input Portion>

Upon accepting the consumption result information 132, the consumption result input portion 112 stores the information in the storage unit 13. The consumption result information 132 is consumption result information of each item. FIG. 4 illustrates an example of a data table of the consumption result information 132. The data table illustrated in FIG. 4 stores, for example, an item 1321, a consumption date 1322, and a consumption quantity 1323. The consumption date 1322 indicates the date of consumption of goods specified by the item 1322 for production or the like.

### <Consumption Result Input Portion>

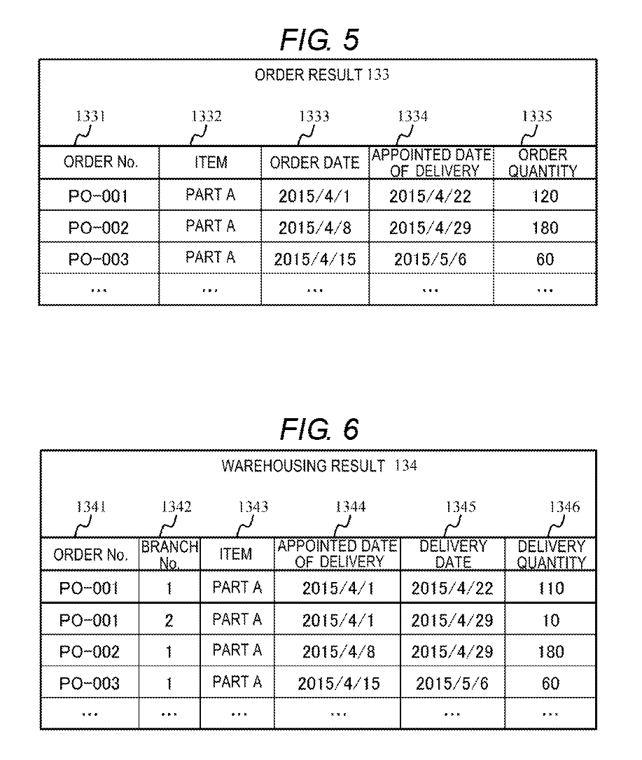

Upon accepting the order result information 133, the order result input portion 113 stores the information in the storage unit 13. The order result information 133 is order result information of each item. FIG. 5 illustrates an example of a data table of the order result information 133. The data table illustrated in FIG. 5 stores, for example, an order number 1331, an item 1332, an order date 1333, an appointed date of delivery 1334, and an order quantity 1335.

### <Warehousing Result Input Portion>

Upon accepting the warehousing result information 134, the warehousing result input portion 114 stores the information in the storage unit 13. The warehousing result information 134 is warehousing result information of each item. FIG. 6 illustrates an example of a data table of the warehousing result information 134. The data table illustrated in FIG. 6 stores, for example, an order number 1341, a branch number 1342, an item 1343, an appointed date of delivery 1344, a delivery date 1345, and a delivery quantity 1346.

### <Consumption Plan Input Portion>

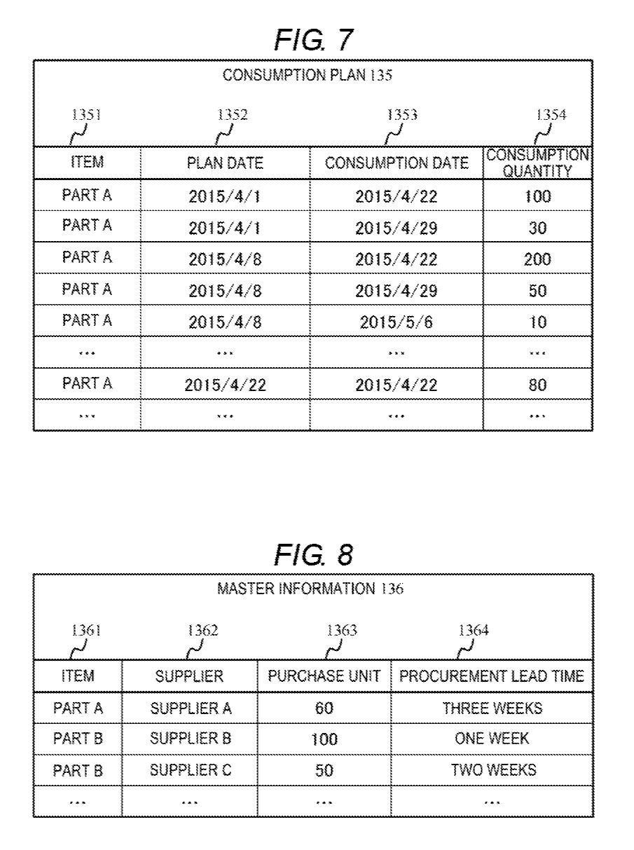

Upon accepting the consumption plan information 135, the consumption plan input portion 115 stores the information in the storage unit 13. The consumption plan information 135 is consumption plan information on each plan date of each item. FIG. 7 illustrates an example of a data table of the consumption plan information 135. The data table illustrated in FIG. 7 stores, for example, an item 1351, a plan date 1352, a consumption date 1353, and a consumption quantity 1354. Here, since a visual numeric character of the consumption plan information 135 varies depending on a plan-making timing, it is necessary to read a numeric character of a decided date. For example, when a plan is made every Monday, consumption plan information of every Monday is read as input information.

### <Master Information Input Portion>

Upon accepting the master information 136, the master information input portion 116 stores the information in the storage unit 13. The master information 136 is purchase unit and procurement lead time information of each item for each supplier. FIG. 8 illustrates an example of a data table of the master information 136. The data table illustrated in FIG. 8 stores, for example, an item 1361, a supplier 1362, a purchase unit 1363, and a procurement lead time 1364.

### (FIG. 2: Step S2: Setting of Analysis Target)

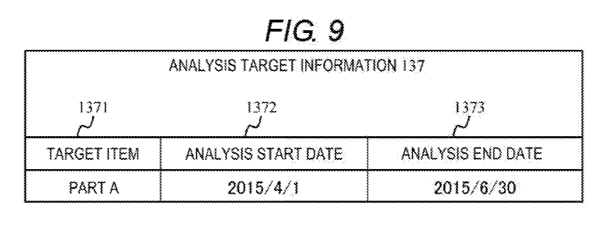

In step S2 in FIG. 2, a process of setting an analysis target is executed. Step S2 is performed by the analysis target accepting portion 117. Upon accepting the analysis target information 137, the analysis target accepting portion 117 stores the information in the storage unit 13. The analysis target information 137 is, for example, information on an item to be analyzed and an analysis period. The analysis period is a period during which the inventory excess/deficiency reason of the item to be analyzed is analyzed. FIG. 9 illustrates an example of a data table of the analysis target information 137. The data table illustrated in FIG. 9 stores, for example, a target item 1371, an analysis start date 1372, and an analysis end date 1373.

### (FIG. 2: Step S3: Repetitive Execution)

Step S3 in FIG. 2 is a process performed by the repetitive arithmetic portion 121 of the arithmetic unit 12. The following steps S4 to S6 are repeatedly executed for the inventory excess/deficiency reason of the analysis target item 1371 stored in the analysis target information 137 every day from the analysis start date 1372 to the analysis end date 1373, and the reason is calculated.

### (FIG. 2: Step S4: Calculation of Warehousing-Induced Quantity)

The warehousing-induced quantity calculating portion 122 calculates the quantity induced by an excess/deficiency reason, which is associated with the warehousing process, out of the excess/deficiency reasons of the item. The excess/deficiency reason associated with the warehousing process may include a cause of purchase unit or a cause of procurement fluctuation. In part procurement, there are cases where order quantities are made in bulk for the purpose of discounts due to a large volume purchase. By the order in bulk, goods (parts) are purchased more than necessary. A difference between the required number and the purchase quantity (order quantity) is a purchase unit-induced quantity which is an inventory fluctuation quantity caused by the purchase unit.

On the other hand, when the supply capacity of the supplier is restricted or a transportation delay occurs, it may not be delivered as ordered. When the supply capacity of the supplier is restricted, a “partial delivery” occurs in which the order quantity (order quantity of the supplier) is partially delivered. Due to the partial delivery or the like, a difference occurs between the order quantity (order result) and an actually delivered quantity (warehousing result). The difference corresponds to a procurement fluctuation-induced quantity that is an inventory fluctuation quantity due to the fluctuation of the procurement quantity.

The warehousing-induced quantity calculating portion 122 reads out the order result information 133, the warehousing result information 134, the consumption plan information 135, and the master information 136 from the storage unit 13, and calculates the purchase unit-induced quantity and the procurement fluctuation-induced quantity from these types of information 133 to 136. However, the warehousing-induced quantity is not limited to the purchase unit-induced quantity and the procurement fluctuation-induced quantity. Other factors may be included in the warehousing-induced quantity.

In this embodiment, the description is given by classifying the cause of the warehousing of the item excess/deficiency reason into the cause of purchase unit and the cause of procurement fluctuation. The warehousing-induced quantity is calculated in order from the analysis start date. In the embodiment, as illustrated in the example of the consumption plan information 135 in FIG. 7, the date on which consumption occurs for the first time is “2015/4/22”. Since there is no change in inventory until the consumption occurs, a calculation procedure from the analysis start date to the day before the first consumption date is omitted, and the description will be given from 2015/4/22 when the first consumption occurs.

First, the warehousing-induced quantity calculating portion 122 calculates the required procurement quantity on 2015/4/22. The warehousing-induced quantity calculating portion 122 reads out master information related to a part A, which is a target part, from the master information 136 illustrated in FIG. 8. The warehousing-induced quantity calculating portion 122 acquires information that the part A can be purchased from the supplier 1362: supplier A, under conditions of the purchase unit 1363: 60 and the procurement lead time 1364: three weeks.

Here, since the procurement lead time is three weeks, the warehousing-induced quantity calculating portion 122 can calculate the required procurement quantity on 2015/4/22 from the consumption plan planned on 2015/4/1, which is three weeks before the consumption date 2015/4/22. The warehousing-induced quantity calculating portion 122 acquires the consumption quantity 1354: 100 before the consumption date 1353 being 2015/4/22, from the consumption plan information 135 illustrated in FIG. 7.

The warehousing-induced quantity calculating portion 122 confirms, from the order result information 133 illustrated in FIG. 5, that the part A is not ordered prior to the order date 1333 being 2015/4/1. Thus, the warehousing-induced quantity calculating portion 122 knows that an ordered non-warehousing quantity, which has been ordered but has not yet been delivered, is zero.

If a record of the results ordered prior to 2015/4/1 remains on the order result information 133, the warehousing-induced quantity calculating portion 122 compares the order result information 133 with the warehousing result information 134 illustrated in FIG. 6, and calculates the ordered non-warehousing quantity.

The warehousing-induced quantity calculating portion 122 calculates the required procurement quantity on 2015/4/22 by subtracting the ordered non-warehousing quantity from the required consumption plan quantity (the required procurement quantity (100)=the required consumption plan quantity (100)−the ordered non-warehousing quantity (0)).

Next, the warehousing-induced quantity calculating portion 122 calculates a purchase unit-induced quantity. Since the procurement lead time is three weeks as in the case of calculating the required procurement quantity, it is possible to calculate a difference due to the purchase unit at the time of 2015/4/22 from the order result ordered on 2015/4/1, which is three weeks before the first consumption date being 2015/4/22.

Thus, the warehousing-induced quantity calculating portion 122 acquires, from the order result information 133 illustrated in FIG. 5, the order quantity 1335 under conditions of the order No. 1331: PO-001, the item 1332: part A, the order date 1333: 2015/4/1, and the appointed date of delivery 1334: 2015/4/22. In this case, the order quantity 1335 is 120.

According to the master information 136 illustrated in FIG. 8, the purchase unit 1363 of the item 1361: part A is 60. Since the required procurement quantity is 100, it can be understood that an order is made with 120 which is a multiple of the purchase unit being 60. Out of multiples of the purchase unit, the smallest value that is equal to or greater than the required procurement quantity is the order quantity. The required quantity is 100, and the order quantity is 120. Therefore, the warehousing-induced quantity calculating portion 122 calculates the purchase unit-induced quantity from the difference between both quantities (the purchase unit-induced quantity (20)=the order quantity (120)−the required consumption plan quantity (100)).

Finally, the warehousing-induced quantity calculating portion 122 calculates a procurement fluctuation-induced quantity. The warehousing-induced quantity calculating portion 122 calculates the procurement fluctuation-induced quantity based on whether goods are received in the warehouse according to the delivery date, from the warehousing result information 134 illustrated in FIG. 6 with respect to the order No. 1331: PO-001.

According to the warehousing result information 134 illustrated in FIG. 6, since two branch numbers 1342 are set in the order number 1341: PO-001, it can be understood that the order is partially delivered. Referring to the appointed date of delivery 1345, it can be understood that the delivery quantity 1346 is 110 which is delivered on 2015/4/22, which is the delivery date. Therefore, the warehousing-induced quantity calculating portion 122 knows that the quantity delivered on 2015/4/22, which is the delivery date, is 110 against the order quantity being 120. Thus, the warehousing-induced quantity calculating portion 122 calculates the procurement fluctuation-induced quantity from a difference between the order quantity and the delivery quantity (the procurement fluctuation-induced quantity (−10)=the delivery quantity (110)−the order quantity (120)).

From the above description, the inventory fluctuation quantity caused by the warehousing is summarized that the required procurement quantity of the part A on 2015/4/22 can be calculated to be +100, the purchase unit-induced quantity thereof can be calculated to be +20, and the procurement fluctuation-induced quantity thereof can be calculated to be −10, respectively.

### (FIG. 2: Step S5: Calculation of Releasing-Induced Quantity)

The releasing-induced quantity calculating portion 123 calculates the quantity caused by the excess/deficiency reason associated with a releasing process, out of the excess/deficiency reasons of the item. As the excess/deficiency reason associated with the releasing process, there are a cause of demand fluctuation and a cause of countermeasure.

In the embodiment, part procurement is performed based on the consumption plan information 135, but a plan value has fluctuated when the part has arrived and excess or deficiency of inventory may occur. In the embodiment, the difference caused by the fluctuation from such the time to the time of actual consumption is referred to as a demand fluctuation-induced quantity.

In a term-end process, parts that are not expected to be consumed in the future (so-called dead stocks) may be disused. In addition, some parts are used as jigs used for inspection or the like. As described above, parts (goods) may be consumed in an unplanned manner. The difference caused by such unplanned consumption is referred to as a countermeasure-induced quantity in the embodiment.

Although not illustrated in the embodiment, there are cases where goods can hardly be released because the inventory is insufficient relative to the required quantity and where defective goods, which could not be released in the previous week, are released with a delay. The difference between a plan and a result caused by the defective goods can also be referred to as a defective goods-induced quantity.

The releasing-induced quantity calculating portion 123 reads out the consumption result information 132, the consumption plan information 135, and the master information 136 from the storage unit 13, and calculates the demand fluctuation-induced quantity, the defective goods-induced quantity, and the countermeasure-induced quantity. The releasing-induced quantity is not limited to the example described above. Other reasons may be added.

As an example, the cause of demand fluctuation will be described below as an item excess/deficiency reason due to the releasing. The releasing-induced quantity calculating portion 123 sequentially calculates from the analysis start date as in step S5, but since the fluctuation does not occur until 2015/4/22 at which the consumption occurs for the first time, the description of a calculation procedure up to the day before the first consumption date from the analysis start date will be omitted, and the description will be given from a releasing-induced quantity at the time of 2015/4/22.

First, the releasing-induced quantity calculating portion 123 calculates a required consumption plan quantity at the order time of 2015/4/22. The required consumption plan quantity has already calculated as 100 in step S4: calculation of the warehousing-induced quantity. In other words, the required consumption plan quantity can also be referred to as a scheduled consumption quantity.

Next, the releasing-induced quantity calculating portion 123 acquires, from the consumption plan information 135 illustrated in FIG. 7, the consumption quantity under conditions of the item 1351: item A, the plan date: 2015/4/22, and the consumption date: 2015/4/22. The consumption quantity is 80.

The releasing-induced quantity calculating portion 123 acquires, from the consumption result information 132 illustrated in FIG. 4, the consumption quantity 1323 under conditions of the item 1321: part A and the consumption date: 2015/4/22. The consumption quantity 1323 is an actually consumed quantity, and is 80 in this case. Since not only the scheduled consumption quantity but also the actual consumption quantity is 80, it can be understood that the excess or deficiency of inventory does not occur and the consumption can be performed as required.

Therefore, it can be understood that the required consumption plan quantity 100 can be consumed as required on 2015/4/22 which is the consumption date and the consumption quantity on that day is 80.

From the above description, the inventory fluctuation quantity caused by the releasing is summarized that the required consumption plan quantity of the part A on 2015/4/22 can be calculated to be −100 and the fluctuation-induced quantity can be calculated to be +20.

### (FIG. 2: Step S6: Storing of Inventory Excess/Deficiency Reason)

The evaluation portion 124 performs a process of storing the inventory excess/deficiency reason in step S6 of FIG. 2. The evaluation portion 124 creates the inventory excess/deficiency reason information 138 from the inventory transition information 131 and the warehousing-induced quantity and the releasing-induced quantity obtained in steps S4 and S5, and stores the information in the storage unit 13.

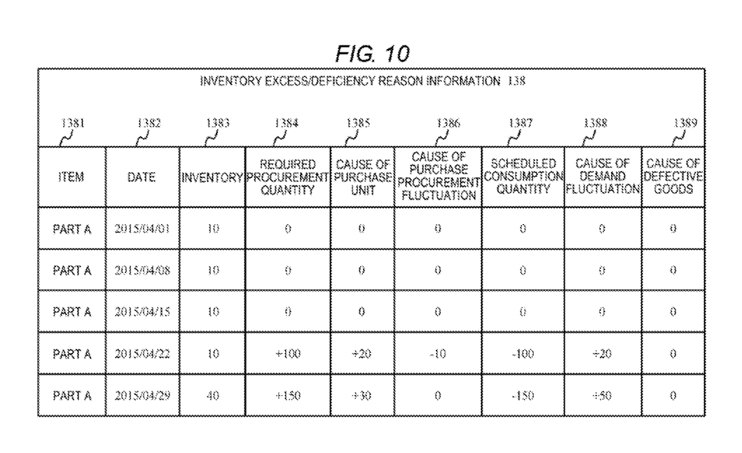

FIG. 10 illustrates an example of a data table of the inventory excess/deficiency reason information 138. The data table illustrated in FIG. 10 stores, for example, an item 1381, a date 1382, an inventory 1383, a required procurement quantity 1384, a cause of purchase unit 1385, a cause of procurement fluctuation 1386, a required consumption plan quantity (indicated as a scheduled consumption quantity) 1387, a cause of demand fluctuation 1383, and a cause of defective goods 1389.

Here, the inventory 1383 is created from the inventory transition information 131. The required procurement quantity 1384, the cause of purchase unit 1385, and the cause of procurement fluctuation 1386 are created from the results calculated by step S4: the warehousing-induced quantity calculating portion 122. The required consumption plan quantity 1387, the cause of demand fluctuation 1383, and the cause of defective goods 1389 are created from the results calculated by step S4: the warehousing-induced quantity calculating portion 122.

### (FIG. 2: Step S7: Display of Inventory Excess/Deficiency Reason)

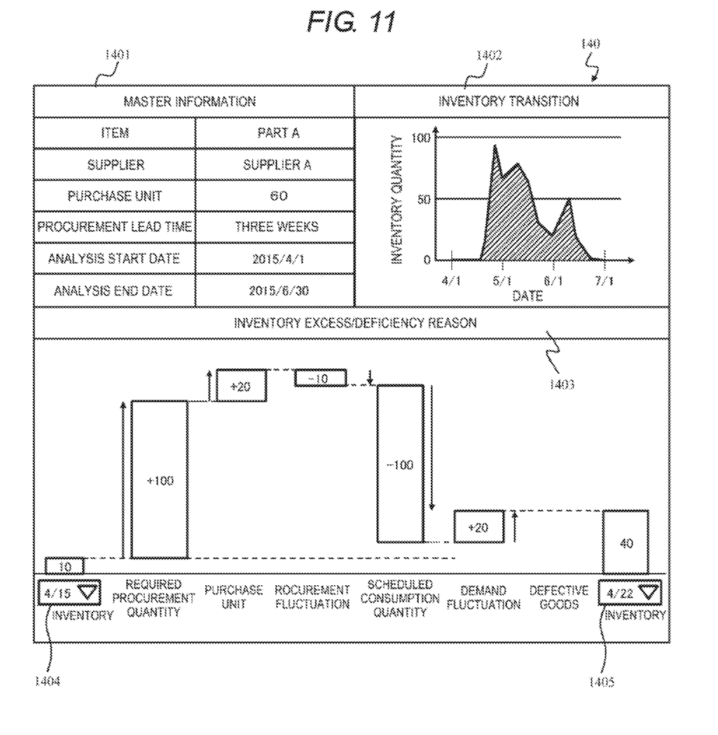

A process of displaying the inventory excess/deficiency reason in step S7 is performed by the inventory excess/deficiency reason output portion 118 of the control unit 11. The inventory excess/deficiency reason output portion 118 outputs the inventory excess/deficiency reason information 138 in the form of a graph. An example of a screen is illustrated in FIG. 11.

An inventory excess/deficiency reason information screen 140 illustrated in FIG. 11 includes, for example, a master information column 1401, an inventory transition column 1402, an excess/deficiency reason column 1403, a start date selection column 1404, and an end date selection column 1405.

The master information column 1401 is created from information acquired from the master information 136 and the analysis target information 137. The inventory transition column 1402 is created from the inventory transition information 131. The excess/deficiency reason column 1403 is created from information on the period from the start date selection column 1404 to the end date selection column 1405 rather than the inventory excess/deficiency reason information 138. In a case of overlapping multiple dates, the warehousing-induced quantity and the releasing-induced quantity may be displayed as a cumulative value or may be displayed in a stacked bar graph format.

An output format may be a format where bar graphs are arranged side by side as illustrated in FIG. 11 or another graph format. Further, for example, the inventory excess/deficiency reason may be output to the network or the storage device in an arbitrary data format, or may be output in another output format.

Focusing on the inventory excess/deficiency reason column 1403, the inventory quantity of the part A of the analysis target is 10 pieces on 2015/04/15 which is the first date. The required procurement quantity obtained from the consumption plan information 135 is 100 pieces. However, since it is necessary to purchase the part A in increments of 60 pieces, 120 parts are purchased (ordered), which is 20 pieces more than the required quantity.

Although the 120 parts are ordered, the quantity of the part A actually delivered on the delivery date is only 110 for some reasons, and the remaining 10 parts are not delivered. In this way, the warehousing-induced quantity is 20 pieces which increase due to the purchase unit and 10 pieces which decreases due to the procurement fluctuation. That is, the inventory fluctuation quantity (warehousing-induced quantity) due to the warehousing is 10 pieces.

On the releasing side, the product is assembled using the part A and is sent to a shipping process or the like. Here, 100 parts are planned to be consumed for the product assembly. In reality, however, the actual consumption quantity does not match the planned value due to reason such as cancellation of orders. In the example illustrated in FIG. 11, the quantity of the actually consumed part A is 80, and the remaining 20 parts are indicated by a bar graph.

The user knows from the inventory excess/deficiency reason column 1403 illustrated in FIG. 11 that an initial inventory of the part A before the start of the analysis is 10 pieces, the inventory of the part A is increased by 10 pieces due to the reason on the warehousing side, and the inventory of the part A is also increased by 20 pieces due to the reason on the releasing side.

In the embodiment having the configuration described above, the inventory tracing device 1 classifies the inventory excess/deficiency reason into the cause of warehousing and the cause of releasing, and the quantities caused by the warehousing and the releasing can be calculated in order of warehousing and releasing from comparison of a theoretical value and an actual value. Therefore, the inventory tracing device 1 according to the embodiment makes it possible to clarify the inventory excess/deficiency reason of the item.

Furthermore, since the inventory tracing device 1 of the embodiment can output the inventory excess/deficiency reason, it can cooperate with, for example, an order management system or a production management system.

Furthermore, since the inventory tracing device 1 of the embodiment can calculate the inventory fluctuation quantity for each cause such as the cause of purchase unit, the cause of procurement fluctuation, or the cause of demand fluctuation, the user can concretely grasp that which causes the inventory excess/deficiency is due to which causes, and usability is improved.

Further, since the inventory tracing device 1 of the embodiment can analyze the inventory excess/deficiency reason within a set period, the cause of the inventory excess/deficiency can be analyzed according to the length of product manufacturing period, and usability is improved. For example, the inventory tracing device of the embodiment can cope with both of a case where the period from the part procurement to the shipment of the product is relatively short like home electrical products and a case where the period from the part order to the completion of construction is relatively long like a power plant.

Further, since the inventory tracing device 1 of the embodiment can visually output the inventory excess/deficiency reason, the user can easily grasp at first sight whether the excess or deficiency of the inventory occurs somewhat for some reasons, and usability is improved.

### Second Embodiment

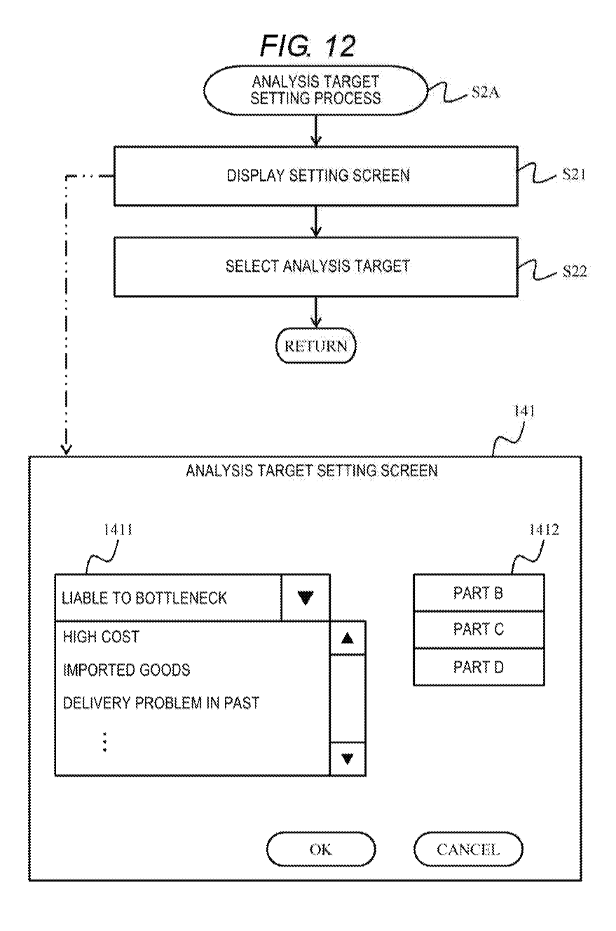

A second embodiment will be described with reference to FIG. 12. Since the following embodiments including this embodiment correspond to a modified example of the first embodiment, differences from the first embodiment will be mainly described. In the present embodiment, goods to be analyzed can be selected from a predetermined viewpoint prepared in advance.

The flowchart of FIG. 12 illustrates step S2A which is a detailed modification of the process (S2) of setting the analysis target described in FIG. 2. That is, step S2A in FIG. 12 can be replaced with step S2 in FIG. 2.

In the present embodiment, when the process proceeds to the process of setting the analysis target (S2A), a screen 141 for setting the analysis target is displayed on the user terminal 2 (S21). The user selects the analysis target using the screen 141 (S22).

As illustrated in the lower part of FIG. 12, the analysis target setting screen 141 includes, for example, a viewpoint selection column 1411 and an item extraction column 1412. The viewpoint selection column 1411 is used to select a viewpoint for analysis target extraction. Examples of the viewpoint may include clauses of “liable to a bottleneck”, “high cost”, “imported goods”, and “delivery problem in the past”. The user can also add viewpoints. When the user selects the viewpoint of the analysis target, the item related to the selected viewpoint is displayed on the item extraction column 1412.

The correlation between the viewpoint and the item (goods) may be performed manually by the user, or a list of the correlation between the viewpoint and the item may be transmitted from a computer (not illustrated) to the inventory tracing device 1. After step S2A is executed, step S3 and subsequent steps in FIG. 2 are executed.

In the present embodiment having the configuration described above, the same operational effects as those of the first embodiment can also be obtained. In the present embodiment, the user can easily extract and select goods to be analyzed by selecting any of the viewpoints prepared in advance. Therefore, the user can analyze by paying attention to the part where the excess or deficiency of the inventory is likely to be caused, and usability is improved. For example, the user can analyze the inventory excess/deficiency reason with respect to products constituted by many parts, products using special imported goods, parts purchased from special factories with small production capacity, or expensive parts.

### Third Embodiment

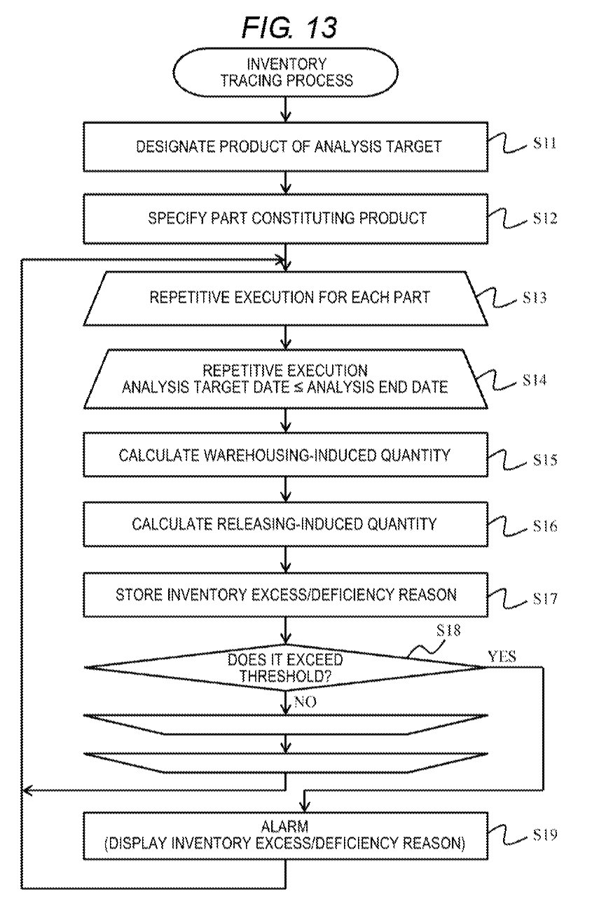

A third embodiment will be described with reference to FIG. 13. In the present embodiment, when the user designates the product to be analyzed, the user analyzes the inventory excess/deficiency reasons of the respective parts constituting the product.

FIG. 13 is a flowchart illustrating an operation of the inventory tracing device 1 according to the present embodiment.

First, the inventory tracing device 1 acquires information for specifying the product to be analyzed, from the user terminal (S11). The user selects the product to be analyzed for the inventory excess/deficiency reason from a product list displayed on the user terminal 2.

The inventory tracing device 1 specifies respective parts constituting the product designated by the user (S12). The inventory tracing device 1 executes processing of steps S14 to S17 described below for each part specified in step S12 (S13).

In step S14, the inventory tracing device 1 repeatedly and sequentially executes the following steps S15 to S18 for the inventory excess/deficiency reason of the part (item) to be analyzed every day from the analysis start date to the analysis end date and calculates the inventory excess/deficiency reason of the part. Since steps S14 to S17 correspond to steps S3 to S6 in FIG. 2, the description thereof will not be presented.

In step S18, the inventory tracing device 1 determines whether to exceed a predetermined threshold set for each of the cause of purchase unit, the cause of procurement fluctuation, and the cause of demand fluctuation. When the threshold is exceeded for any cause (S18: YES), the inventory tracing device 1 displays the excess/deficiency reason and issues a warning to the user (S19). A warning message or a warning mark displayed on the screen of the user terminal 2 or an electronic mail directed to the user can give warning to the user.

In the present embodiment having the configuration described above, the same operation effects as those of the first embodiment can also be obtained. In the present embodiment, only by designation of the product, the reason for the inventory excess or deficiency of the respective parts constituting the product is analyzed, and a warning is issued when necessary. Therefore, it is possible to manage the inventory of the product at all times and to analyze whether each process of procurement and production is problematic, and usability is improved.

It should be noted that the present invention is not limited to the above-described embodiments, but includes various modified examples. The above-described embodiments are described in order to facilitate understanding of the present invention, and thus the present invention is not necessarily limited to including all of the configurations described above.

The components, the functions, the process units, the process means and the like may be achieved by hardware, for example by designing a part or all of them with an integrated circuit or the like. In addition, the components, the functions and the like may be achieved by software using a processor interpreting and carrying out a program achieving the functions. The information about the programs, tables, files and the like for achieving the functions can be saved in a recording apparatus such as a memory, a hard disk and an SSD (Solid State Drive) or a recording medium such as an IC card, an SD card and a DVD.

### REFERENCE SIGNS LIST

1: inventory tracing device
11: control unit
12: arithmetic unit
13: storage unit
117: analysis target accepting portion
118: inventory excess/deficiency reason output portion
122: warehousing-induced quantity calculating portion
123: releasing-induced quantity calculating portion

1. An inventory analysis device for analyzing an inventory of a target article, comprising:
a warehousing-induced quantity calculating portion that calculates, from information on warehousing of the target article, an inventory fluctuation quantity caused by the warehousing; and
a releasing-induced quantity calculating portion that calculates, from information on releasing of the target article, an inventory fluctuation quantity caused by the releasing.

2. The inventory analysis device according to claim 1, further comprising:
an output portion that outputs the inventory fluctuation quantity caused by the warehousing and the inventory fluctuation quantity caused by the releasing.

3. The inventory analysis device according to claim 2, wherein
the information on the warehousing includes plan information and result information on the warehousing of the target article, and
the information on the releasing includes plan information and result information on the releasing of the target article.

4. The inventory analysis device according to claim 3, wherein
the plan information on the warehousing of the target article and the plan information on the releasing include consumption plan information created for consumption of the target article,
the warehousing result information includes order result information indicating an order result of the target article and warehousing result information indicating an actually warehoused quantity out of an order quantity, and
the releasing result information includes consumption result information indicating an actually consumed quantity out of the target article.

5. The inventory analysis device according to claim 4, wherein
the warehousing-induced quantity calculating portion or the releasing-induced quantity calculating portion calculates an inventory fluctuation quantity for each different cause.

6. The inventory analysis device according to claim 5, further comprising:
a period setting portion that sets a period to be calculated by the warehousing-induced quantity calculating portion and the releasing-induced quantity calculating portion.

7. The inventory analysis device according to claim 1, wherein
the output portion visually outputs the inventory fluctuation quantity caused by the warehousing and the inventory fluctuation quantity caused by the releasing.

8. The inventory analysis device according to claim 1, further comprising:
an analysis target setting portion that selects the target article by selecting any one of predetermined viewpoints prepared in advance.

9. The inventory analysis device according to claim 1, wherein
the warehousing-induced quantity calculating portion and the releasing-induced quantity calculating portion respectively calculate an inventory fluctuation quantity using each of parts constituting a selected product as the target article.

10. An inventory analysis method of analyzing an inventory of a target article using a computer,
the computer calculating, from information on warehousing of the target article, an inventory fluctuation quantity caused by the warehousing,
the computer calculating, from information on releasing of the target article, an inventory fluctuation quantity caused by the releasing, and
the computer outputting the inventory fluctuation quantity caused by the warehousing and the inventory fluctuation quantity caused by the releasing.
